(19) United States
(12) Patent Application Publication
(10) Pub. No.: US 2010/0219984 A1
(43) Pub. Date: Sep. 2, 2010

(54) Traffic Communication System and Method for Communicating in Traffic

(75) Inventor: Tom Marnix Alexander De Wilde, Lisse (NL)

Correspondence Address: THE WEBB LAW FIRM, P.C., 700 KOPPERS BUILDING, 436 SEVENTH AVENUE, PITTSBURGH, PA, 15219, US

(73) Assignee: STICHTING NOBLE HOUSE, Lisse (NL)

(21) Appl. No.: 12/532,448

(22) PCT Filed: Mar. 25, 2008
(86) PCT No.: PCT/NL2008/050167

§ 371 Date: Mar. 24, 2010

(30) Foreign Application Priority Data
Mar. 27, 2007 (NL) 2000561

(51) Int. Cl. G08G 1/09; H04B 10/04; H04B 10/06

(52) U.S. Cl. 340/905; 398/182; 398/202

(57) ABSTRACT

A traffic communication system comprising a laser transmitter arranged for emitting a pulsating laser signal, wherein at least one message has been encoded into the pulse sequence of the laser signal, a laser receiver arranged for receiving the pulsating laser signal, and a central processing unit arranged for determining said at least one message in the pulse sequence of the received signal and carrying out a command in dependence on the message received.

The invention relates to a traffic communication system. As the traffic intensity increases, road safety has become an increasingly serious problem. The more vehicles there are on the road at the same time, the greater the risk of accidents. The increasing traffic intensity furthermore leads to traffic jams, especially during rush hours, which is not only a nuisance for the drivers in question, but which, in addition, leads to considerable economic losses.

Accidents frequently occur especially in sections where a speed limit applies, for example near road construction sites or near schools, but also when vehicles join a traffic jam. Usually these accidents are caused by sudden braking, on the one hand in response to the prescribed speed limit and on the other hand in response to the braking of vehicles in front on account of said speed limit.

Although it has been attempted to solve these problems by using electronic speed limit signs or even permanent speed indicators, a major speed reduction appears to come unexpectedly for many drivers, which may lead to multiple collisions and the like.

The known system has attempted to tackle these problems by presenting current and updated traffic information to the vehicles via roadside radar beacons. Said beacons emit a radar signal which includes traffic information that is relevant to the area in question. When a vehicle drives past a beacon, said signal is picked up by the vehicle and converted into a message for the driver. In this way relevant information is presented to the driver, so that the driver will be better able to deal with changing traffic situations.

Thus, a signal which alerts a driver to children crossing may for example be emitted near schools, in the case of roadworks the reduced speed may be communicated, but also under normal circumstances information may be communicated, for example information regarding the allowed maximum speed.

A drawback of such a system is the fact that a transmission license is required for transmitting messages via radar signals. This presents problems, as the system works best when a large number of radar beacons transmit relevant information.

Another drawback of the known system is the fact that the range of the system is limited: only vehicles within the range of the radar beacon can receive the information being transmitted, although it would be conceivable that it would be desirable to increase the range, for example in the case of a drastic speed reduction.

Furthermore, only the beacons can function as signal sources in the known system. Thus, no information would be available in the case of a traffic jam that spontaneously develops at an unusual location.

The object of the invention is to provide an efficient, practical, versatile system which is easy to control and install and/or which has a safety-enhancing effect, which system exhibits the above drawbacks to a lesser extent.

In order to accomplish that object, the system comprises a laser transmitter arranged for emitting a pulsating laser signal, wherein at least one message has been encoded into the pulse sequence of the laser signal, a laser receiver arranged for receiving the pulsating laser signal, and a central processing unit arranged for determining said at least one message in the pulse sequence of the received signal and carrying out a command in dependence on the message received. Such a system provides a reliable communication system for which a transmission license is not required and which enables very localised communication, for example within one lane.

In a preferred embodiment, the system further comprises an audio and/or visual output unit arranged for communicating the message to a driver of a vehicle. Likewise in the preferred embodiment, the signal processing unit is arranged for determining a plurality of messages in the pulse sequence of the received signal.

The laser transmitter is preferably arranged for emitting the pulsating laser signal in a plurality of directions, so that a wide range of possible receivers is covered as may be desired.

The laser receiver is preferably arranged for receiving the pulsating laser signal at a plurality of locations on a vehicle, so that also a wide range of possible directions of the transmitters is covered.

In the preferred embodiment, the system further comprises at least one relay device comprising a laser receiver arranged for emitting a pulsating laser signal in response to the receipt of a pulsating laser signal by the laser receiver. In this way a vehicle can for example transfer the message to following vehicles. Said emitted pulsating laser signal may be a copy of the received pulsating laser signal, but it may also be another message than the original message.

In one embodiment the message to be transmitted is automatically triggered by an event in the vehicle in which the laser transmitter is located, for example an emergency stop or the activation of the hazard warning lights.

The message may furthermore comprise a text message. The system may comprise an input device by means of which the driver can input a message, which message is encoded into the laser signal. In this way a very versatile communication system is realised.

The laser transmitter may furthermore be a beacon disposed in a housing at a fixed roadside location. Said beacon may emit a permanent allowed maximum speed message, for example. It may also form part of a pay-as-you-drive system, for example. The beacon may furthermore be provided with a relay device for transferring messages received from other beacons or vehicles. The beacon is furthermore preferably provided with a laser receiver and a signal processing unit arranged for determining said at least one message in the pulse sequence of the received signal. In this way the beacon can receive and process messages from vehicles in an interactive manner.

The laser transmitter may also be disposed in a first vehicle and the laser receiver may be disposed in a second vehicle, so that vehicles can communicate with each other. In the preferred embodiment, a vehicle comprises a laser transmitter as well as a laser receiver.

The invention further relates to a traffic communication system comprising a laser transmitter arranged for emitting a pulsating laser signal and a laser receiver arranged for receiving said pulsating laser signal. The system furthermore preferably comprises at least one relay device comprising a laser transmitter arranged for emitting a pulsating laser signal in response to the receipt of a pulsating laser signal by the laser receiver. In a preferred embodiment, the emitted pulsating laser signal is a copy of the received pulsating laser signal.

The invention also relates to a laser transmitter, a laser receiver and/or a central processing unit for use in a system as described above.

The invention further relates to a vehicle provided with at least a laser transmitter, a laser receiver and/or a central processing unit.

The invention also relates to a method for communicating messages in traffic. According to said method, a pulsating laser signal is emitted, preferably by means of a laser transmitter, wherein said at least one message is encoded into the pulse sequence of the laser signal, wherein a laser receiver receives the pulsating laser signal and a central processing unit determines said at least one message in the pulse sequence of the received signal and carries out a command in dependence on the received message.

The invention also relates to a method for communicating in traffic wherein a pulsating laser signal is emitted by means of a laser transmitter, wherein a laser receiver in a vehicle receives the pulsating laser signal, wherein a pulsating laser signal is emitted by a laser transmitter in the vehicle in response to the receipt of a pulsating laser signal by the laser receiver, and wherein the pulsating laser signal is emitted in rearward direction, seen in the direction of movement, by the laser transmitter in the vehicle.

The invention will be explained in more detail with reference to an embodiment as shown in the figures, in which:

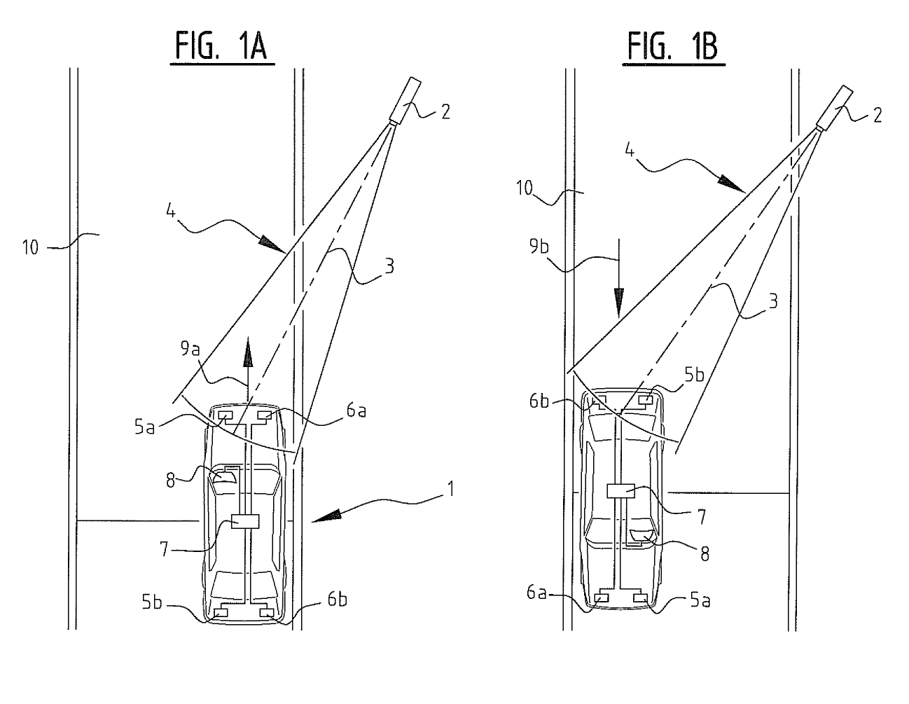

FIGS. 1a and 1b schematically show the receipt of information from a beacon;

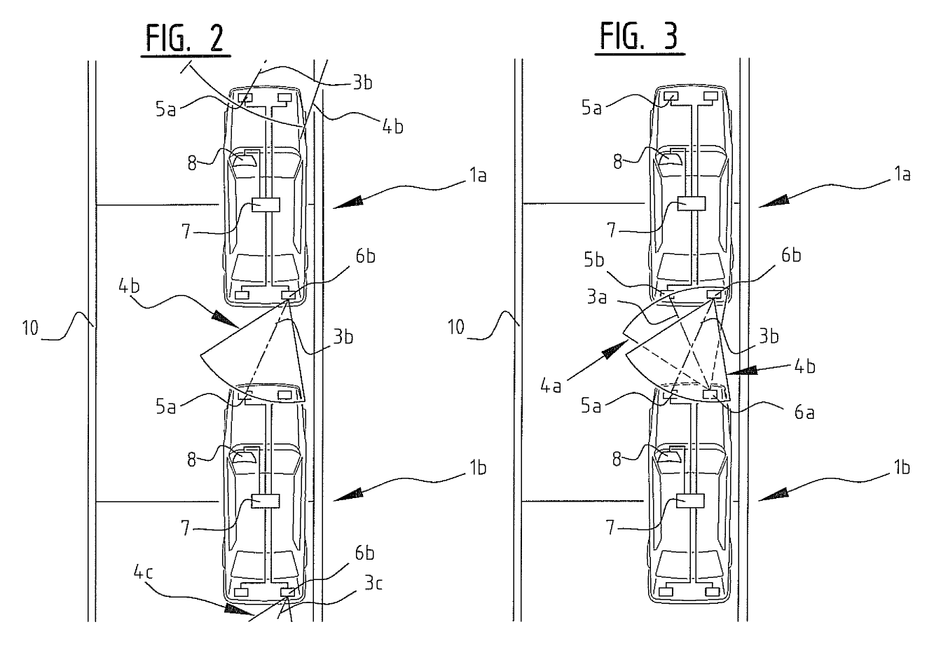

FIG. 2 schematically shows the transfer of information between various vehicles; and

FIG. 3 schematically shows the communication between two vehicles.

FIG. 1a shows a vehicle 1 driving in a direction 9a on a road 10. A permanent or mobile beacon 2 is disposed at the side of the road 2, which beacon comprises a laser transmitter in a housing, which emits a laser beam 3. Since a single laser beam 3 has a very narrow range, the transmitter in the beacon 2 is capable of emitting the signal in a plurality of directions, thus forming a laser bundle 4.

When the vehicle 1 drives past, the laser beam 3 from the laser bundle 4 is received in a receiver 5a at the front side of the vehicle 1. A message has been encoded in the pulse sequence of the laser beam 3, which message may be a text message containing information regarding the traffic situation, for example.

The signal of the received laser beam 3 is supplied to a central processing unit 7, where the message is decoded and transferred to one of the modules 8, which may include a display screen, for example, for communicating the message to the driver. The laser beam 3 may also contain more than one message, which are individually determined by the central processing unit 7 in that case.

Although the width of the laser bundle shown in FIG. 1a is fairly small, this must not be considered to be limitative, as is shown in FIG. 1b, in which the vehicle 1 drives in a direction 9b and the receiver 5b at the rear side of the vehicle 1 also receives the laser beam 3 from the beacon 2. To have the receipt of the laser beam 3 take place in a more efficient manner, the vehicle 1 may be fitted with a plurality of receivers 5a and 5b.

FIG. 2 schematically shows the manner in which a laser beam 3a from a bundle 4a can be transferred to a plurality of vehicles by means of a relay device. The laser beam 3a from a bundle 4a, for example from a vehicle in front, a beacon, or a laser gun, is received in the receiver 5a of a first vehicle 1a. The message is decoded in the central processing unit 7 and output to the modules 8, for example, for being communicated to the driver. The signal is also transferred to a transmitter 6b at the rear side of the vehicle 1a, which emits a bundle 4a. A laser beam 3b from said bundle 4b is subsequently received in the receiver 5a of a following vehicle 1b. Also in this case the message is decoded in the central processing unit 7 and output to the modules 8, and in this case, too, the signal is emitted in a bundle 4c to a following vehicle via the transmitter 6b.

It is furthermore possible to provide the beacon 2 of FIG. 1a with a receiver, so that it can also function as a relay device for transferring messages and/or signals.

FIG. 3 schematically shows the communication between two vehicles 1a and 1b. As shown, the vehicle 1a emits a bundle 4b to the vehicle 1b by means of the transmitter 6b, and the laser beam 3b from the bundle 4b is received in the receiver 5a of the vehicle 1b. The encoded message is output to the modules 8 via the receiver 5a and the central processing unit 7 of the vehicle 1b. The vehicle 1b in turn emits a bundle 4a with an encoded message to the vehicle 1a by means of the transmitter 6a, which bundle 4a is received in the receiver 5b of the vehicle 1a via a laser beam 3a. This message, too, is output to the modules 8 of the vehicle 1a in the known manner.

In this way it is possible for vehicles to communicate with each other. Think in this connection of text messages that drivers send each other, but also of information originating from the vehicle. It is possible to transfer a message to the following vehicle, for instance when braking hard. Vehicles may also transfer message in unchanged form or communicate that they are receiving a laser signal. Furthermore, traffic information from a beacon 2, for example, may be transferred to following vehicles.

1-23. (canceled)

24. A traffic communication system comprising:
a laser transmitter arranged for emitting a pulsating laser signal, with at least one message encoded into a pulse sequence of the laser signal;
a laser receiver arranged for receiving the pulsating laser signal; and
a central processing unit arranged for determining said at least one message in the pulse sequence of the received signal and carrying out a command in dependence on the message received.

25. The traffic communication system according to claim 24, further comprising an audio and/or visual output unit arranged for communicating the message to a driver of a vehicle.

26. The traffic communication system according to claim 24, wherein the signal processing unit is arranged for determining a multitude of messages in the pulse sequence of the received signal.

27. The traffic communication system according to claim 24, wherein the laser transmitter is arranged for emitting the pulsating laser signal in a plurality of directions.

28. The traffic communication system according to claim 24, wherein the laser receiver is arranged for receiving the pulsating laser signal at a plurality of locations.

29. The traffic communication system according to claim 24, further comprising at least one relay device comprising a laser receiver arranged for emitting a pulsating laser signal in response to the receipt of a pulsating laser signal by the laser receiver.

30. The traffic communication system according to claim 24, wherein the emitted pulsating laser signal is a copy of the received pulsating laser signal.

31. The traffic communication system according to claim 24, wherein the message to be transmitted is automatically triggered by an event in the vehicle in which the laser transmitter is located.

32. The traffic communication system according to claim 24, wherein said message comprises a text message.

33. The traffic communication system according to claim 24, further comprising an input device by means of which the driver can input a message, which message is encoded into the laser signal.

34. The traffic communication system according to claim 24, wherein the laser transmitter is a beacon disposed in a housing at a fixed roadside location.

35. The traffic communication system according to claim 34, wherein the beacon includes a laser receiver and a signal processing unit arranged for determining said at least one message in the pulse sequence of the received signal.

36. The traffic communication system according to claim 35, wherein the beacon includes a relay device.

37. The traffic communication system according to claim 24, wherein the laser transmitter is disposed in a first vehicle and the laser receiver is disposed in a second vehicle.

38. The traffic communication system according to claim 37, wherein the vehicle includes a laser transmitter as well as a laser receiver.

39. A traffic communication system comprising:
a laser transmitter arranged for emitting a pulsating laser signal;
a laser receiver arranged for receiving said pulsating laser signal; and
at least one relay device comprising a laser transmitter arranged for emitting a pulsating laser signal in response to the receipt of a pulsating laser signal by the laser receiver.

40. The traffic communication system according to claim 39, wherein the emitted pulsating laser signal is a copy of the received pulsating laser signal.

41. A laser transmitter according to claim 24.

42. A laser receiver according to claim 24.

43. A central processing unit according to claim 24.

44. A vehicle provided with at least a laser transmitter, a laser receiver and/or a central processing unit according to claim 24.

45. A method for communicating messages in traffic, wherein a pulsating laser signal is emitted by means of a laser transmitter, wherein said at least one message is encoded into a pulse sequence of the laser signal, and wherein a laser receiver received the pulsating laser signal and a central processing unit determines said at least one message in the pulse sequence of the received signal and carries out a command in dependence on the received message.

46. A method for communicating in traffic, wherein a pulsating laser signal is emitted by means of a laser transmitter, wherein a laser receiver in a vehicle received the pulsating laser signal, wherein a pulsating laser signal is emitted by a laser transmitter in the vehicle in response to the receipt of a pulsating laser signal by the laser receiver, and wherein the pulsating laser signal is emitted in rearward direction, seen in the direction of movement, by the laser transmitter in the vehicle.
